(19) United States
(12) Patent Application Publication
(10) Pub. No.: US 2022/0067963 A1
(43) Pub. Date: Mar. 3, 2022

(54) Method for monitoring the position of a jockey wheel of a trailer, camera system for monitoring the position of a jockey wheel of a trailer, and motor vehicle comprising a camera system

(71) Applicant: Conti Temic microelectronic GmbH, Nürnberg (DE)

(72) Inventor: Günter Anton Fendt, Schrobenhausen (DE)

(73) Assignee: Conti Temic microelectronic GmbH, Nürnberg (DE)

(21) Appl. No.: 17/310,147

(22) PCT Filed: Dec. 11, 2019
(86) PCT No.: PCT/DE2019/200145

§ 371 Date: Jul. 21, 2021

(30) Foreign Application Priority Data
Jan. 22, 2019 (DE) 10 2019 200 753.8

(51) Int. Cl. G06T 7/73; B60D 1/66

(52) U.S. Cl. CPC G06T 7/74; B60S 9/16; B60D 1/665

(57) ABSTRACT

The example embodiment(s) relates to a method for monitoring the position of a jockey wheel of a trailer, including sensing a region lying behind a motor vehicle by means of a camera, processing the sensed image data by means of an evaluation unit and identifying the jockey wheel, and determining the position of the jockey wheel, comparing the sensed position of the jockey wheel with a secured position of the jockey wheel, and outputting a warning signal if the sensed position of the jockey wheel deviates from the secured position. The example embodiment(s) further relates to a camera system and to a motor vehicle including a camera system according to the example embodiment(s).

### CROSS REFERENCE TO RELATED APPLICATIONS

This application is a National Stage Application under 35 U.S.C. 371 of International Application No. PCT/DE2019/200145 filed on Dec. 11, 2019, which claims priority from DE 10 2019 200 753.8, filed on Jan. 22, 2019, the disclosures of which are herein incorporated by reference in their entireties.

### FIELD OF INVENTION

The invention relates to a method for monitoring the position of a jockey wheel of a trailer, a camera system for monitoring the position of a jockey wheel of a trailer, and a motor vehicle comprising a camera system.

### BACKGROUND

Nowadays, it is difficult to imagine motor vehicles without driver assistance systems. Driver assistance systems have functions which support the driver of a vehicle while driving. This is in particular achieved in that the system senses or records the environment and processes the sensed information and then performs corresponding driving maneuvers or reproduces the environmental information for the driver. In particular, cameras which sense at least certain areas of the space around the vehicle are deployed for this. For example, front cameras which are arranged in the region of the windshield and sense a region in front of the vehicle are known. Backwards-looking cameras, such as reversing cameras, have now further become part of the prior art. In particular, these sense a region lying behind the vehicle. Surround-view systems are also increasingly being deployed.

Although today's motor vehicles increasingly have trailer hitches, towing trailers is not commonplace. One known utilization of trailers is transporting large items of furniture, in particular when moving into a house. Trailers are further deployed in the form of motorhomes. The trailer is only used for these purposes occasionally, so a certain amount of time can elapse between each utilization of the trailer. Consequently, the process of attaching a trailer is not a routine operation, meaning that errors are made a great many times, which can be associated with dire consequences.

To ensure that the trailers have a secured footing when they are not being utilized, trailers have jockey wheels. If the trailers are arranged on a motor vehicle, the jockey wheels are raised and fixed. Due to the unevenness of the ground, it can happen during a journey that the jockey wheels, in particular if they are not fastened properly, become detached. This can damage the jockey wheel or, in the worst case, this can lead to a traffic hazard.

### SUMMARY

Starting from this, it is now an object to provide a method or a system with which a trailer can be towed securely and, in particular, without any accidents.

According to a first aspect, the disclosed example embodiment(s) relates to a method for monitoring the position of a jockey wheel of a trailer, including the steps:
sensing a region lying behind a motor vehicle by means of a camera,
processing the sensed image data by means of an evaluation unit, identifying the jockey wheel, and determining the position of the jockey wheel,
comparing the sensed position of the jockey wheel with a secured position of the jockey wheel, and
outputting a warning signal if the sensed position of the jockey wheel deviates from the secured position.

In particular, the method according to the example embodiment(s) ensures that the position of a jockey wheel of a trailer is monitored, such as continually during a journey. If the position of the jockey wheel changes, then the driver is informed about this. The driver can thus take appropriate measures before an accident risk arises or before the jockey wheel is damaged. The driver can, for example, stop the motor vehicle and reattach the jockey wheel. The overall result is that a trailer can be towed securely.

The jockey wheel is in particular identified with an object identification method which is known in image processing.

The warning signal may be output optically and/or acoustically. It is advantageous if the driver is informed about the position of the jockey wheel on a display device, in particular on a monitor and/or a head-up display. It is advantageous if at least an image detail of the camera is represented to the driver, wherein overlays or highlightings, which are in particular configured in color, are inserted if the position of the jockey wheel deviates from the secured position. This ensures that the driver is informed in a simple and easily recognizable manner about an incorrect position of the jockey wheel.

It is conceivable that a multi-stage warning may be effected. If the jockey wheel only deviates marginally from the secured position, an alternating sound or an alternating beeping may be effected. If the position of the jockey wheel deviates more and more from the secured position, the acoustic signal may be converted into a continuous sound or continuous beeping. Likewise, the optical warning may change, in particular it may change color. The highlighting or overlay may change color. The color particularly changes from yellow to orange to red.

In a configuration, the warning signal is only output if a distance or a difference exists between the sensed position of the jockey wheel and the secured position, which exceeds a threshold.

A secured position within the meaning of the present disclosure is in particular understood to be a position of the jockey wheel in which there should not be any damage to the jockey wheel during the operation of the motor vehicle. The jockey wheel is in particular located in the secured position if it is arranged at a sufficient distance from the roadway. In an advantageous configuration of the example embodiment, the secured position is a defined distance between the jockey wheel in the secured position, in particular in a nominal position, and the roadway. Within the meaning of the present disclosure, the defined distance is in particular viewed as a nominal distance. The nominal distance is stored.

In an example configuration, a warning signal is output if the distance of the sensed jockey wheel from the roadway is smaller than the defined distance. It is advantageous if the warning signal is only output if the distance of the sensed jockey wheel deviates from the defined distance by a threshold or a difference. The threshold is stored in the system. In this case, it is advantageous that the driver does not receive a warning for even the tiniest deviation, even though there is no potential risk.

The secured distance of the jockey wheel and/or the nominal distance and/or the threshold is/are stored in a storage unit and can be called up.

It is advantageous if it is checked whether a trailer is present. The check can be effected by means of a camera, in particular a reversing camera, by analyzing an electrical contacting and/or by means of trailer hitch bearing load identification. If a trailer has been identified, the camera is then in particular activated.

The method according to the invention is only performed if the motor vehicle is moving. It is also possible that the method is activated if the engine of the motor vehicle is started.

According to a second aspect, the example embodiment(s) relates to a camera system for monitoring the position of a jockey wheel of a trailer, including at least one camera which senses a region lying behind a motor vehicle; an evaluation unit for processing the sensed image data, wherein the evaluation unit is configured in such a manner that the jockey wheel is identified and the position of said jockey wheel is determined; a comparison device which is configured in such a manner that the sensed position of the jockey wheel is compared with a secured position of the jockey wheel; and a warning device for outputting a warning signal if the sensed position of the jockey wheel deviates from the secured position.

In particular, the system according to the example embodiment(s) ensures that a trailer is towed securely. Even those persons who only tow a trailer intermittently can be spared unnecessary annoyance with the system according to the example embodiment(s).

In a configuration, the system can include a storage unit. The secured position and/or a nominal distance and/or a threshold is/are stored in the storage unit. The storage unit can be part of the evaluation unit. It is also conceivable that the comparison unit is part of the evaluation unit.

The camera is advantageously a reversing camera. This creates added value for the driver since a camera which is already present on the motor vehicle and only has a very limited range of functions acquires an additional function. It is, however, also in principle possible that the camera is a camera from a surround-view system which is in particular arranged in a rear section of the motor vehicle.

The camera system according to the invention is in particular suitable for performing a method according to the example embodiment(s).

According to a third aspect, the example embodiment(s) relates to a motor vehicle having a camera system according to the example embodiment(s).

### BRIEF DESCRIPTION OF THE DRAWINGS

Further advantageous configurations are set out in the drawings, wherein:

FIG. 1 shows a schematic representation of a flow chart of a method according to the example embodiment for monitoring the position of a jockey wheel of a trailer in a configuration;

FIG. 2 shows a schematic representation of a motor vehicle including a camera system according to the example embodiment(s) in a configuration;

FIG. 3 shows a schematic representation of a motor vehicle including a camera system according to the example embodiment(s) in a further configuration.

### DETAILED DESCRIPTION

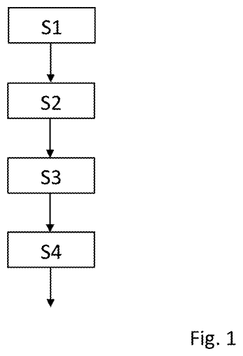

FIG. 1 shows a schematic representation of a flow chart of a method according to the example embodiment(s) for monitoring the position of a jockey wheel 18 of a trailer 16 in a configuration. In a first step S1, a region lying behind a motor vehicle 12 is sensed by means of a camera 14. In a second step S2, the sensed image data of the camera 14 are analyzed by means of an evaluation unit 22. The jockey wheel 18 is identified and the position of the jockey wheel 18 is determined. In order to identify the jockey wheel 18, known object identification methods may be enlisted. In a third step S3, the sensed position of the jockey wheel 18 is compared with a secured position of the jockey wheel 18. The secured position may be a distance between the jockey wheel 18 in a secured position, in particular in a nominal position, and the roadway 30. The distance is stored in a storage unit 28. In a fourth step S4, a warning signal is output if the sensed position of the jockey wheel 18 deviates from the secured position. The warning signal is only output if the distance of the sensed jockey wheel 18 from the roadway 30 is smaller than the nominal distance and deviates from the secured distance by a threshold.

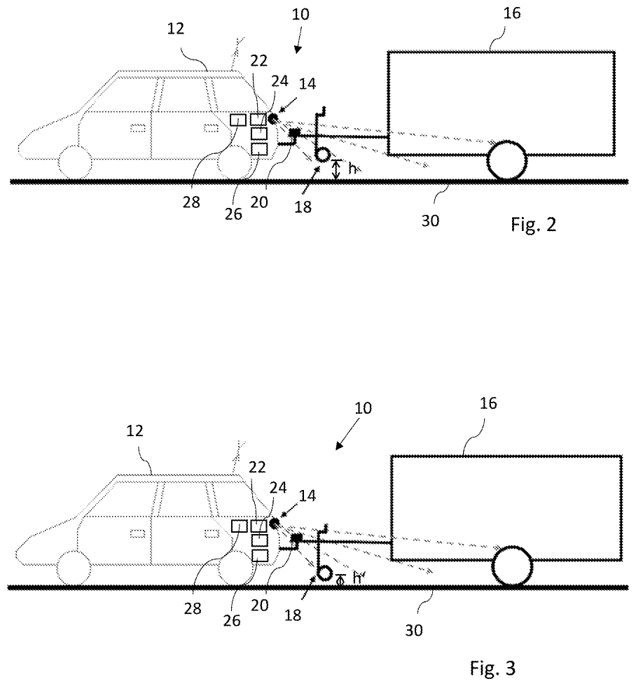

FIG. 2 shows a schematic representation of a motor vehicle 12 including a camera system 10 according to the example embodiment(s) for monitoring the position of a jockey wheel 18 of a trailer 16 in a configuration. The camera system 10 has a camera 14 which senses a region lying behind a motor vehicle 12. The sensing region of the camera 14 is depicted in FIG. 2 by the dashed arrows. The camera system 10 further has an evaluation unit 22. The evaluation unit 22 processes the sensed image data. As a result, the jockey wheel 18 may be identified and its position may be determined. The system 10 further includes a comparison device 24. The comparison device 24 compares the sensed position of the jockey wheel 18 with a secured position of the jockey wheel 18. The secured position of the jockey wheel 18 is stored in a storage unit 28. Moreover, the system 10 includes a warning device 26 for outputting a warning signal if the sensed position of the jockey wheel 18 deviates from the secured position.

In FIG. 2, the sensed jockey wheel 18 is a distance h from the roadway 30. The distance substantially corresponds to a nominal distance stored in the storage unit 28. Consequently, there is no risk due to the jockey wheel 18 during the operation of the motor vehicle 12 so that no warning is emitted.

FIG. 3 shows a schematic representation of a motor vehicle 12 including a camera system 10 according to the example embodiment(s) in a further configuration. The system 10 depicted in FIG. 3 fundamentally corresponds to the system 10 depicted in FIG. 2. It is merely the position of the jockey wheel 18 that differs from one another. In FIG. 3, the jockey wheel 18 is a distance h′ from the roadway 30. The distance h′ is smaller than the stored nominal distance, in particular the distance h′ deviates from the nominal distance by a threshold. The warning device 26 consequently outputs a warning signal.

The invention has been described above with reference to example embodiments. It is understood that numerous alterations and modifications are possible, without departing from the scope of protection defined by the claims. A combination of the various example embodiments is also possible.

### LIST OF REFERENCE NUMERALS

10 Camera system
12 Motor vehicle
14 Reversing camera
16 Trailer
18 Jockey wheel
20 Trailer hitch
22 Evaluation unit
24 Comparison device
26 Warning device
28 Storage unit
30 Roadway
h Height of the jockey wheel from the ground
S1-S4 Method steps

1. A method for monitoring the position of a jockey wheel of a trailer, comprising:
sensing a region lying behind a motor vehicle by means of at least one camera to generate sensed image data,
processing the sensed image data by means of an evaluation unit identifying the jockey wheel, and determining the position of said jockey wheel,
comparing the sensed position of the jockey wheel with a secured position of the jockey wheel, and
outputting a warning signal if the sensed position of the jockey wheel deviates from the secured position.

2. The method according to claim 1, wherein the secured position is a defined distance between the jockey wheel and a roadway.

3. The method according to claim 2, wherein the warning signal is output if the distance of the sensed jockey wheel from the roadway is smaller than the defined distance.

4. The method according to claim 1, wherein the secured position of the jockey wheel is stored in a storage unit.

5. The method according to claim 1, further comprising checking whether a trailer representation is present in the sensed image data.

6. A camera system for monitoring a position of a jockey wheel of a trailer, in particular for performing a method according to claim 1, comprising the at least one camera which senses the region lying behind the motor vehicle, the evaluation unit for processing the sensed image data, wherein the evaluation unit is configured in such a manner that the jockey wheel is identified and the position of said jockey wheel is determined, a comparison device which is configured in such a manner that the sensed position of the jockey wheel is compared with the secured position of the jockey wheel, and a warning device for outputting the warning signal if the sensed position of the jockey wheel deviates from the secured position.

7. The camera system according to claim 6, further comprising a storage unit, in which the secured position, in particular a nominal distance between the jockey wheel and a roadway, is stored.

8. The camera system according to claim 6, wherein the at least one camera is a reversing camera.

9. A motor vehicle comprising the camera system according to claim 6.

10. A camera system for monitoring a position of a jockey wheel of a trailer, comprising:
at least one camera which senses a region lying behind the motor vehicle and generates sensed image data;
an evaluation unit coupled to the at least one camera and configured to process the sensed image data, wherein the evaluation unit is configured to perform a method comprising:
identifying a jockey wheel representation in the sensed image data and determining the position of the jockey wheel based upon the identified jockey wheel representation, and
comparing the determined position of the jockey wheel with a secured position of the jockey wheel; and
a warning device which, based upon the comparison, outputs a warning signal if the determined position of the jockey wheel deviates from the secured position.

11. The camera system according to claim 10, wherein the secured position is a defined distance between the jockey wheel and a ground surface on which the trailer is located.

12. The camera system according to claim 11, wherein determining the position of the jockey wheel comprises determining a distance of the jockey wheel to the ground surface, wherein the warning signal is output if the determined distance of the sensed jockey wheel from the ground surface is smaller than the defined distance.

13. The camera system according to claim 10, further comprising memory, wherein the secured position of the jockey wheel is stored in the memory.

14. The camera system according to claim 10, wherein the at least one camera comprises at least one reversing camera.
